(19) United States
(12) Patent Application Publication
(10) Pub. No.: US 2005/0007763 A1
(43) Pub. Date: Jan. 13, 2005

(54) Lighted tool for vehicle door unlocking system

(75) Inventors: Frank Child, Cody, WY (US); Lawrence D. Steck, Dayton, OH (US)

Correspondence Address: Joseph G. Nauman, 696 Renolda Woods Ct., Dayton, OH, 45429-3415, US

(73) Assignee: Steck Manufacturing Company, Inc., Dayton, OH (US)

(21) Appl. No.: 10/886,195

(22) Filed: Jul. 7, 2004

Related U.S. Application Data
(60) Provisional application No. 60/487,043, filed on Jul. 11, 2003.

(51) Int. Cl. F21V 33/00

(52) U.S. Cl. 362/109

(57) ABSTRACT

A probe for achieving entry into a locked vehicle cab, includes an integrated light which can emit a bright directed beam from its actuating end to facilitate locating such end onto or against a chosen door lock release mechanism. The probe is a completely independent unit, comprising an appropriately shaped and relatively stiff rod (preferably tubular), having a tip at the insertion end of the rod including an LED or comparable small source of light. A battery pack or comparable energy source is fitted to the probe, preferably incorporated into the probe handle which remains exterior of the vehicle door during use. In the preferred embodiment electrical conductors are incorporated in (or pass through) the rod and a switch is located on the probe handle to control application of electrical energy to the light source.

### RELATED APPLICATION

This application is based upon, and claims the priority of, prior U.S. Provisional Application Ser. No. 60/487,043 filed Jul. 11, 2003, and incorporates herein by reference the entire disclosure of that application.

### BACKGROUND OF THE INVENTION

A tool kit marketed by Steck Manufacturing Company, Inc. (under the mark BigEasy) enables a user to perform an entry method set forth in U.S. Pat. No. 6,591,473, to actuate the interior door handle, or manual lock button, or electric lock button, or the lock pin, on a variety of automotive vehicles, such as cars, trucks, and SUV vehicles, so as to gain entry when the vehicle is accidentally locked with the doors and windows closed, and must be entered for some reason. Such a situation is often encountered by emergency repair/response and towing service personnel.

A probe as disclosed in said '473 Patent is passed into the vehicle cab, ordinarily through a gap formed by prying the door perimeter away from the door frame, with the probe inner actuating end located within the vehicle body and the probe manipulating handle exterior of the door. As described and illustrated in said '473 Patent, movement of the inner actuating end within the vehicle's cab is in full view of the user through the door window. The use of such probe for unlocking vehicles is quick and so easy little training is needed for the users. It has been discovered, however, that under conditions of darkness or poor ambient lighting (to which tinted window glass may contribute), a user may have difficulty in locating the actuating end against a selected release mechanism, and (if he is alone as is the usual circumstance) handling a light outside the vehicle to illuminate areas within the cab interior. Such a circumstance may impair the user's facility to manipulate the probe.

### SUMMARY OF THE INVENTION

The present invention provides a probe with an integrated light which can emit a bright directed beam from its actuating end to facilitate locating such end onto or against the chosen door lock release mechanism. The probe is a completely independent unit, comprising an appropriately shaped and relatively stiff rod (preferably tubular), a tip at the insertion end of the rod including an LED or comparable small source of light, and a battery pack or comparable energy source. Preferably the energy source is incorporated into the probe handle which remains exterior of the vehicle door during use. In the preferred embodiment electrical conductors are incorporated in (or pass through) the rod and a switch is located on the probe handle to control application of electrical energy to the light source. Alternate forms of self-contained light are also possible.

Other objects and advantages of the invention will be apparent from the following description, the accompanying drawings, and the appended laims.

### BRIEF DESCRIPTION OF DRAWINGS

FIG. 1 is a fore-shortened view of the probe of the invention;

FIG. 2 is an exploded view on a larger scale, illustrating the illuminating actuating end of the probe, according to this invention;

FIG. 3 is an exploded view, also on a larger scale, illustrating an energy source incorporated into the probe handle; and

FIG. 4 is an enlarged view, partially in cross-section, showing a version of the light and energy source which can be attached to the tip of a probe rod.

### DESCRIPTION OF PREFERRED EMBODIMENTS

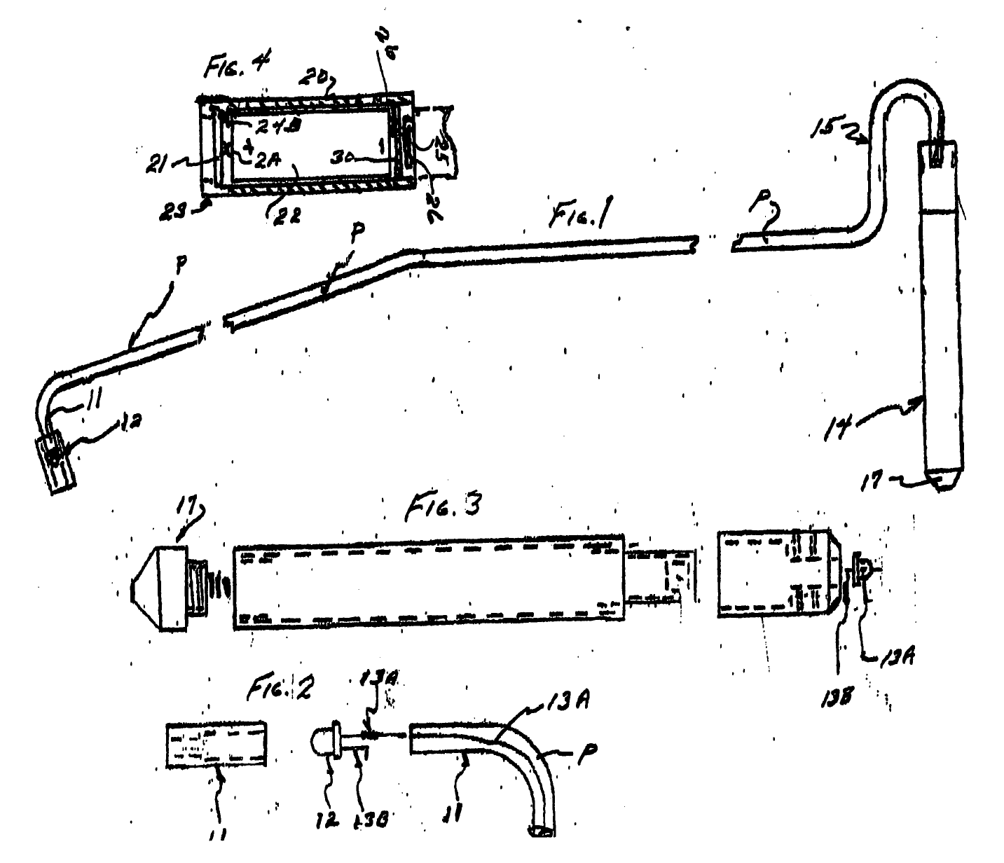

According to this invention the long rod-like metal probe P is relatively stiff and is formed preferably of tubular material so as to contain appropriate electrical wiring. The actuator end or tip 11 (FIGS. 1 & 2), is a translucent cover press fitted to the actuator end of probe P, extending approximately perpendicular to the length of the probe, and incorporating a small lamp 12, such as a light emitting diode (LED). The LED is connected by internal wiring 13 (FIG. 2) to a battery case 14 which is provided as part of the manipulating handle 15 of the probe. A convenient wiring includes an insulated wire 13A passed through probe P, and a ground connection 13B attached to probe P and case 14. The case 14 may be cylindrical or, for example, ergonomically shaped to provide a grip to the user.

A typical embodiment of this probe is formed from 0.250 diameter steel or copper tubing. The tubing preferably provides one part of the electrical connection (usually negative) and a single insulated wire 13A connects the battery (ies) in case 14 through the tube to the LED which is covered by translucent tip member 11 As in the original probe, this probe is essentially rigid, but is somewhat flexible along its length due to its diameter/length ratio. A pair of AA size batteries in case 14 provide adequate energy to the LED and a suitable switch 17, e.g. a toggle ON-OFF switch, controls the power application to the LED. The switch may be covered by a flexible protective membrane.

In an actual embodiment, an LED flashlight has been used by removing its LED emitter, mounting it within tip 11 of the actuator end of a tubular probe, and wiring it to the battery case of the flashlight which is, in turn, fitted to the handle of the probe. In that embodiment the rod is formed of steel or stiff copper tube and is electrically conductive to provide a ‘ground’ portion of the electrical circuit along with connections 13B to the rod from the battery case 14 and the LED; the second conductor is a single wire 13A extending within the tubular probe.

Also, it is possible to provide a solid probe with external conductor strips, at least one of which is electrically insulated, which are attached tightly to the probe exterior and also covered by an electrically insulating substance.

Alternate lighting systems may be used. For example, the body of the probe may be provided as a light pipe (provided it has adequate stiffness using a small diameter material), and the LED can be mounted within the battery case 14 so as to direct light along the ‘light pipe’ body to emit light from its actuator tip.

Another example of such a light is illustrated in FIG. 4, wherein an attachment to the probe tip 11 is provided as a small housing 20 of sufficient size to carry an LED 21 (as in FIG. 2) and a miniature battery 22 (e.g. an AAA size battery). The LED is supported within a housing 20 which includes at least a translucent end part 23 around the LED. Electric contacts 24A, 24B are located on the back side of the LED's mounting plate, and a ground wire extends from contact 24B (negative) to the upper or ground contact region of battery 22. The contact 24A (positive) touches the positive contact of the battery

The upper end of housing 20 has one or more arcuate slots 25 through it which include a detent portion 26. A corresponding number of short pins 26, extending laterally from the probe tip 11, are arranged to enter the slots, and engage in the detent portions 26 upon rotation of housing 20.

A compressible disc 30 rests on the negative or ground contact wire of the battery, and when housing 20 is secured in place by the pin-detent arrangement, compression of the disc urges the contacts 24A, 24B of the LED against the negative and positive battery contacts, so as to turn the LED light on.

The preferred embodiment uses a case 14 large enough to receive a pair of AA batteries, and a toggle switch on the case which can be manipulated by the user's thumb as the user grips the handle/case. It is believed this arrangement offers the best results as to battery life and convenient manipulation of the lighted probe.

While the forms of apparatus herein described constitute preferred embodiments of the invention, it is to be understood that the invention is not limited to these precise forms of apparatus, and that changes may be made therein without departing from the scope of the invention which is defined in the appended claims.

1. A lighted probe which can emit a light beam from its actuating end to facilitate locating such end onto a lock release mechanism within the cab of a locked vehicle, including an elongated rod having an insertion end for entry through a vehicle door frame and a handle end for manipulation of the rod from the cab exterior; the improvement comprising
a tip at the insertion end of the rod including a small light emission source,
an electrical energy source incorporated into the probe, and means providing an electrical connection from the energy source to the light emission source.

2. A probe as defined in claim 1, wherein the energy source is a battery pack incorporated into the handle end.

3. A probe as defined in claim 2, wherein said battery pack is a case providing a grip on said handle end.

4. A probe as defined in claim 1 wherein a small compartment is affixed to said tip, and said power source and said light source are supported in said compartment.

5. A probe as defined in claim 1, wherein said rod is a tubular member.

6. A probe as defined in claim 5, wherein the electrical connection includes at least one wire extending through the tubular member.

7. A probe as defined in claim 6, wherein the tubular member is an electrical conductor and provides part of the electrical connection.

8. A probe as defined in claim 1, wherein the light source is an LED supported at the insertion end tip.

9. A probe as defined in claim 8, including a translucent member surrounding the LED and fitted to the insertion end tip.

10. A probe as defined in claim 1, including an electrical switch incorporated in the handle end and connected to control the electrical connection between the energy source and the light source.

11. A lighted probe which can emit a light beam from its actuating end to facilitate locating such end onto a release mechanism within the cab of a locked vehicle, including an elongated rod having an insertion end sized for entry between a vehicle door perimeter and its surrounding door frame and a handle end for manipulation of the rod from the cab exterior; the improvement comprising
a tip at the insertion end of the rod including a small high intensity light emission source,
an electrical energy source incorporated into the rod, and
means providing a circuit between the energy source and the light emission source.
